(19) United States
(12) Patent Application Publication
(10) Pub. No.: US 2016/0012372 A1
(43) Pub. Date: Jan. 14, 2016

(54) CROWD WORKER QUALITY IMPROVEMENT WITH CONTINUING TRAINING

(71) Applicant: Microsoft Corporation, Redmond, WA (US)

(72) Inventors: Rajesh Patel, Woodinville, WA (US); Steven Shelford, Vancouver (CA); Yunling Wang, Redmond, WA (US)

(21) Appl. No.: 14/328,680

(22) Filed: Jul. 10, 2014

(51) Int. Cl. G06Q 10/06

(52) U.S. Cl. CPC G06Q 10/06395

(57) ABSTRACT

Workers are trained and assisted to improve quality of task results generated by them. Initially, workers seeking to perform intelligence tasks within the context of a crowdsourcing system are provided with offline training. Subsequently, workers are qualified, with different nuances of the performance of intelligence tasks being assessed independently. A task owner specifies minimum quality thresholds, including separately specified thresholds for different nuances. Qualified workers are assigned to perform intelligence tasks, thereby producing useful work. While doing so, their quality is monitored, and online training is provided to aid workers with specific nuances of the intelligence tasks where the workers' performance is suboptimal. Workers whose quality drops below minimum quality thresholds are aided in improving their quality, including being prevented from performing intelligence tasks for a predefined period of time, being mandated to perform offline training, or combinations thereof.

### BACKGROUND

As an increasing number of people gain access to networked computing devices, the ability to distribute intelligence tasks to multiple individuals increases. Moreover, a greater quantity of people can be available to perform intelligence tasks, enabling the performance of such tasks in parallel to be more efficient, and increasing the possibility that individuals having particularized knowledge or skill sets can be brought to bear on such intelligence tasks. Consequently, the popularity of utilizing large groups of disparate individuals to perform intelligence tasks continues to increase.

The term “crowdsourcing” is often utilized to refer to the distribution of discrete tasks to multiple individuals, to be performed in parallel, especially within the context where the individuals performing the task are not specifically selected from a larger pool of candidates, but rather those individuals individually choose to provide their effort in exchange for compensation. Existing computing-based crowdsourcing platforms distribute intelligence tasks to human workers, typically through network communications between the computing devices implementing such crowdsourcing platforms, and each human worker's individual computing device. The intelligence tasks that such human workers are being asked to perform are typically those that do not lend themselves to easy resolution by a computing device, and are, instead, tasks that require the application of human judgment.

Because of the distributed nature of crowdsourcing, in combination with the types of intelligence tasks that are typically crowdsourced, crowdsourcing systems are prone to being taken advantage of by unscrupulous workers who seek to maximize the amount of money they receive from a crowdsourcing system without doing any useful work in return. For example, such unscrupulous workers provide random answers to a task, irrespective of the correctness of such answers, merely so as to receive, as quickly as possible, whatever compensation was due for providing an answer to the task.

Traditionally, crowdsourcing systems detect unscrupulous workers through the use of tasks for which definitive answers or results have already been determined and established. Such tasks are randomly assigned and, to the extent that received responses do not match the definitive answers or results that have already been determined, such discrepancies are utilized as evidence of an unscrupulous worker, and an individual so classified can be prevented from providing further responses to such tasks.

### SUMMARY

Rather than only attempting to identify unscrupulous workers who are intentionally, or apathetically, providing poor quality results, mechanisms can be provided by which workers can be trained and assisted to improve the quality of the results provided by such workers to the intelligence tasks that are assigned to them. Initially, a worker seeking to perform intelligence tasks within the context of a crowdsourcing system can be provided with offline training to prepare the worker to properly perform the intelligence tasks the worker selected. Subsequently, the worker can be qualified in order to perform such intelligence tasks, with different nuances of the performance of such intelligence tasks being assessed independently. A task owner can specify minimum quality thresholds, including separately specified thresholds for different nuances. A qualified worker can then be assigned to the performance of intelligence tasks, thereby producing useful work. While doing so, the quality of the worker's output can continue to be monitored, and online training can be provided to aid the worker with specific nuances of the intelligence tasks where the worker's performance may be suboptimal. A worker whose quality drops below minimum quality thresholds can be aided in improving the quality of their work, including being prevented from performing intelligence tasks for a predefined period of time to give the worker a mental respite, being mandated to perform offline training, or combinations thereof. Workers that complete such aid can return to performing intelligence tasks, while workers that fail to complete such aid, or whose quality drops below minimum quality thresholds too often, can be disqualified.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary system for aiding human workers in performing intelligence tasks within the context of a crowdsourcing system.

FIG. 2 is a block diagram of an exemplary set of components for aiding human workers in performing intelligence tasks within the context of a crowdsourcing system.

FIG. 3 is a flow diagram of an exemplary aiding of human workers in performing intelligence tasks within the context of a crowdsourcing system; and

FIG. 4 is a block diagram of an exemplary computing device.

### DETAILED DESCRIPTION

The following description relates to improving the quality of results to Human Intelligence Tasks (“HITs”) that are generated by human workers in a crowdsourcing system. Rather than only attempting to identify unscrupulous workers who are intentionally, or apathetically, providing poor quality results, mechanisms can be provided by which workers can be trained and assisted to improve the quality of the results provided by such workers to the HITs assigned them. Initially, a worker seeking to perform some of the HITs of an overall task owned by a task owner can be provided with offline training specific to the overall task, thereby preparing the worker to properly perform the HITs. Subsequently, the worker can be qualified in order to perform the HITs of the overall task, with different nuances of the performance of such HITs being assessed independently. The task owner can specify minimum quality thresholds, including separately specified thresholds for different nuances. A qualified worker can then be assigned to the performance of HITs, thereby producing useful work. While doing so, the quality of the worker's output can continue to be monitored, and online training can be provided to aid the worker with specific nuances of the intelligence tasks where the worker's performance may be suboptimal. A worker whose quality drops below minimum quality thresholds can be aided in improving the quality of their work, including being prevented from performing the HITs for a predefined period of time to give the worker a mental respite, being mandated to perform offline training, or combinations thereof. Workers that complete such aid can return to performing HITs, while workers that fail to complete such aid can be disqualified.

The techniques described herein focus on crowdsourcing paradigms, where HITs are performed by human workers, from among a large pool of disparate and diverse human workers, who choose to perform such HITs. However, such descriptions are not meant to suggest a limitation of the described techniques. To the contrary, the described techniques are equally applicable to any human intelligence task processing paradigm, including paradigms where the human workers to whom HITs are assigned are specifically and individually selected or employed to perform such HITs. Consequently, references to crowdsourcing, and crowdsource-based human intelligence task processing paradigms are exemplary only and are not meant to limit the mechanisms described to only those environments.

Although not required, the description below will be in the general context of computer-executable instructions, such as program modules, being executed by a computing device. More specifically, the description will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to stand-alone computing devices, as the mechanisms may also be practiced in distributed computing environments where tasks are performed by remote processing devices that are linked through a communications network. In a distributed computing environment, program modules may be located in both local and remote memory storage devices.

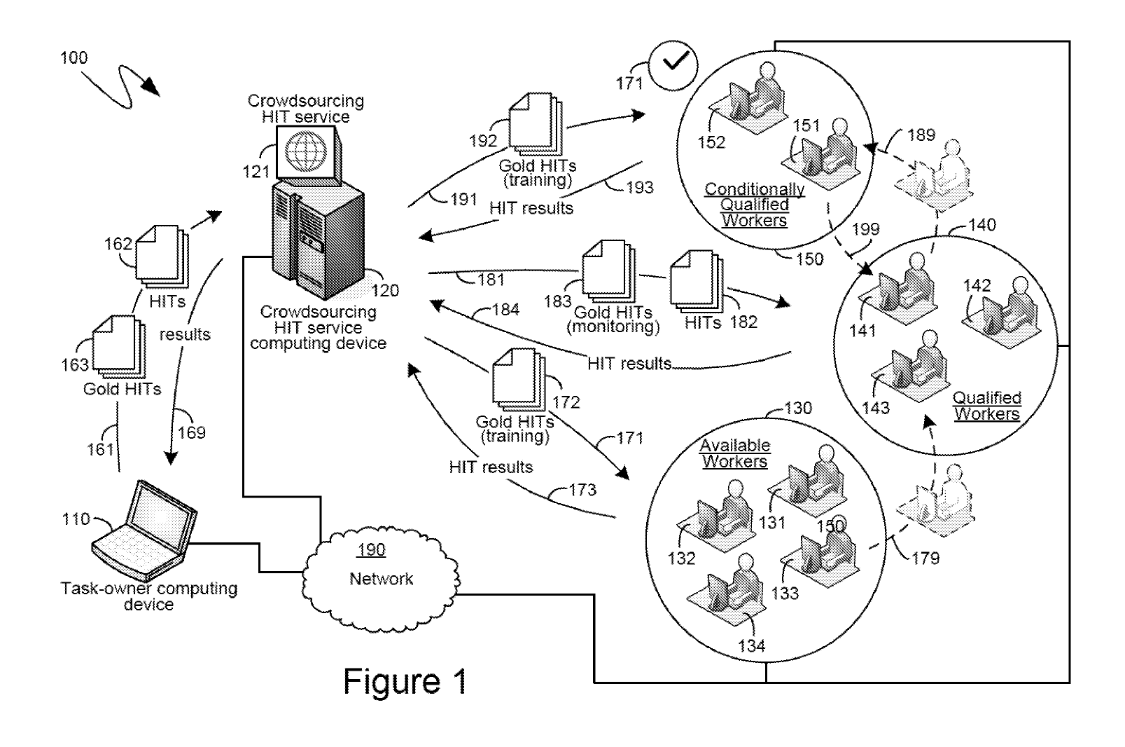

With reference to FIG. 1, an exemplary system 100 is illustrated, providing context for the descriptions below. As illustrated in FIG. 1, the exemplary system 100 can comprise a set of available human workers 130, including the illustrated human workers 131, 132, 133 and 134, that are available to perform intelligence tasks. Additionally, the exemplary system 100 of FIG. 1 can further comprise a crowdsourcing service 121 that can be executed by one or more server computing devices, such as the exemplary server computing device 120. The one or more server computing devices on which the crowdsourcing service 121 executes need not be dedicated server computing devices, and can, instead, be server computing devices executing multiple independent tasks, such as in a cloud-computing paradigm. Only a single exemplary server computing device 120 is illustrated in FIG. 1 to maintain graphical simplicity and legibility, but such an exemplary server computing device 120 is meant to represent any one or more dedicated or cloud-computing server computing devices.

A task owner computing device, such as the exemplary task owner computing device 110, is also illustrated in FIG. 1 as part of the system 100. A task owner can utilize the exemplary task owner computing device 110 to interface with the crowdsourcing service 121 and can, thereby, utilize the crowdsourcing service 121 to obtain performance of intelligence tasks by human workers, such as human workers from the set of available human workers 130. The task owner computing device 110, the server computing devices on which the crowdsourcing service 121 executes, such as exemplary server computing device 120, and the computing devices of the human workers 130, can exchange computer-readable messages and can otherwise be communicationally coupled to one another through a network, such as the exemplary network 190 shown in FIG. 1.

Initially, as illustrated by the exemplary system 100 of FIG. 1, a task owner can upload HITs, such as the exemplary HITs 162, to the crowdsourcing service 121, as represented by the communication 161 from the task owner computing device 110 to the exemplary server computing device 120 on which the crowdsourcing service 121 is executing. As will be recognized by those skilled in the art, and as utilized herein, the term “human intelligence task” (HIT) means a task whose result is to be generated by the application of human intelligence, as opposed to programmatic or machine intelligence. As will also be recognized by those skilled in the art, HITs are typically tasks that require the application of human evaluation or judging. For example, one intelligence task can be a determination of whether one specific web page is, or is not, relevant to one specific search term. Thus, a human worker performing such an intelligence task could be presented with a webpage directed to, for example, the aurora borealis, and a specific search term, such as, for example, “northern lights”, and such a human worker could be asked to determine whether or not the presented webpage is responsive to the presented search term.

An overall task can be composed of a myriad of such individual HITs. Consequently, returning to the above example, the overall task, owned by the task owner, that is comprised of such individual HITs, can be a determination of whether or not a collection of webpages are, individually, relevant to specific ones of a collection of search terms. Consequently, as utilized herein, the term “overall task” means the collection of individual HITs that a task owner desires to have performed by a crowdsourcing service.

In addition to HITs, such as the exemplary HITs 162, a task owner can also provide HITs for which definitive answers or results have already been determined and established. As will be recognized by those skilled in the art, such HITs can be utilized to detect workers who are providing incorrect results to the HITs assigned to them, and are typically referred to as “gold HITs”. Consequently, maintaining convention, the term “gold HIT”, as utilized herein, means an individual task for which a definitive answer or result has already been determined and established, typically by a task owner, and which is utilized in connection with the already determined definitive answer or result. Thus, the term “gold HIT” refers to a HIT that can be utilized, in connection with the already determined definitive answer of such a HIT, to train workers, provide examples, detect incorrect results, or in other contexts where both the task and corresponding definitive answer are concomitantly utilized. Consequently, the communication 161, from the exemplary task owner computing device 110 to the exemplary server computing device 120 on which the crowdsourcing service 121 is executing, can comprise, not only the HITs 162, but also gold HITs 163.

As will be recognized by those skilled in the art, the HITs 162 and the gold HITs 163 can be provided within the context of an application program, or other set of computer-executable instructions that can facilitate the provision of a context through which workers can be presented with, and can provide results to, individual tasks. Such computer-executable instructions are often referred to as a “HITapp” and, maintaining convention, the term “HITapp”, as utilized herein, means the set of computer-executable instructions that provide, or facilitate the provision of, a computer-implemented context through which workers can be presented with, and can provide results to, individual tasks. A HITapp can be provided by a task owner, such as part of the communication 161, or it can be generated by the crowdsourcing service 121, such as based on the HITs and gold HITs provided by a task owner, or, as yet another alternative, a HITapp can be customized by a task owner utilizing existing components or templates provided by a crowdsourcing service, such as the exemplary crowdsourcing service 121.

Initially, one or more of the available workers 130 can select a HITapp through which the worker desires to receive, and respond to, HITs, and receive compensation therefor. As will be recognized by those skilled in the art, the selection of such a HITapp can be based on initial information provided to workers, such as through a HITapp marketplace or other like catalog of HITapps from which workers can choose. In response to such a selection, in accordance with one aspect, the worker, from among the one or more available workers 130, can receive training directed to the overall task whose individual HITs the worker will be performing through the HITapp. Such training can be in the form of gold HITs, such as the exemplary gold HITs 172, which can be provided by the crowdsourcing service 121 to such a worker, from among the available workers 130, with the communication 171. The training can showcase the type of HITs that the worker will be expected to perform, along with sample correct responses to the exemplary HITs, and an explanation of why such responses are correct. Additionally, the training can provide at least some of the gold HITs 172 to the worker to perform, and can then, by comparison with the known correct responses of such gold HITs, determine whether the worker properly performed such gold HITs.

According to one aspect, the results 173, generated by the worker, responsive to the gold HITs 172 that were provided to the worker as part of the training, can be analyzed by the crowdsourcing service 121 to identify the worker's abilities with respect to specific nuances in the performance of the HITs. More specifically, and as indicated previously, HITs typically comprise tasks that require the application of human intelligence. As such, HITs can routinely comprise subjective-ranking-type decisions. For example, HITs directed to determining whether a specific webpage is relevant to a specific search query can require a worker to identify a specific webpage as being “not relevant”, “somewhat relevant” or “very relevant” to a particular query. A worker categorizing a webpage as “somewhat relevant”, when that webpage should have been categorized as “very relevant”, can be as detrimental to the quality of the HIT results as a worker categorizing a webpage as “somewhat relevant”, when that webpage should have been categorized as “not relevant”. Consequently, continuing with the present example, during a training process, the crowdsourcing service 121 can monitor the performance of the worker, in providing results to the gold HITs 172, and can determine whether the worker is properly categorizing webpages. A worker who correctly categorizes “very relevant” webpages as “very relevant”, but who occasionally categorizes “somewhat relevant” webpages as “not relevant”, can be deemed to be deficient in appreciating the nuance between “somewhat relevant” webpages and “not relevant” webpages. As utilized herein, therefore, the term “nuance”, as applied to specific aspects of the performance of HITs, means a distinction between one type, category or level of a subjective evaluation and another, different type, category or level. If the analysis of the results 173, that were generated by the worker responsive to the gold HITs 172, reveals that the worker is deficient with respect to specific nuances in the performance of the gold HITs 172, targeted training, focusing on those specific nuances, can be provided to the worker.

Upon completion of an offline training regiment, the worker can be provided with a qualification test to determine whether the worker will be qualified to perform HITs through the HITapp that the worker selected. Such a qualification can, again, rely on some of the gold HITs 172, providing at least some of the gold HITs 172 to the worker, and then comparing the worker's results 173 to the known correct results of such gold HITs. According to one aspect, in order for the worker to qualify, the quality of the results 173 that are provided by the worker in response to the gold HITs 172 that were provided to the worker as part of the qualification could be required to exceed minimum quality thresholds, which can be established by a task owner, by a crowdsourcing service 121, or by combinations thereof. Such minimum quality thresholds can, according to one aspect, be established independently for different nuances. For example, returning to the above example, a task owner may be more concerned with workers incorrectly identifying “not relevant” webpages as “somewhat relevant” than the task owner would be concerned with workers incorrectly identifying “very relevant” webpages as “somewhat relevant”. Consequently, such a task owner could establish a higher minimum quality threshold for the nuance in distinguishing between “not relevant” and “somewhat relevant” categorizations, and could establish a lower minimum quality threshold for the nuance in distinguishing between “very relevant” and “somewhat relevant” categorizations.

In providing the qualification, the crowdsourcing service 121 can evaluate the HIT results 173 that the worker provides in response to those of the gold HITs 172 that are utilized as the qualification in order to determine the quality levels of the HIT results 173, either generically, or specifically with regard to specific nuances. If the worker does not exceed the minimum quality thresholds established, the worker can remain as part of the available workers 130. Optionally, the worker can be provided targeted training, such as that referenced above, which can focus on specific nuances, should the worker have failed the qualification only on specific nuances. The worker can then be again provided with a qualification test.

If the worker exceeds the minimum quality thresholds established, the worker can be transitioned from the available workers 130 to the qualified workers 140, as illustrated by the transition 179. According to one aspect, those workers, such as the exemplary workers 141, 142 and 143, that are part of the qualified workers 140, can receive HITs 182, such as through a HITapp, and can provide corresponding HIT results 184. The corresponding HIT results 184 can entail the performance of “useful work”, since such HIT results 184 can provide results for HITs that have not previously been performed. In other words, the HIT results 184, responsive to the HITs 182, provided to the qualified workers 140, can be amalgamated by the crowdsourcing service 121 into the results 169 that can, ultimately, be provided to a task owner in response to the overall task uploaded by such a task owner to the crowdsourcing service 121, such as via the aforementioned communication 161. As utilized herein, therefore, the term “useful work” means the provision of HIT results for HITs to which results have not yet been received and for which no definitive results exist.

As part of their performance of useful work, the qualified workers 140, and, more specifically, the HIT results 184 generated by such workers, can be monitored to determine their quality. According to one aspect, gold HITs 183 can, occasionally, be provided to the qualified workers 140, and the HIT results 184 generated by the qualified workers 140, in response to such gold HITs 183, can be evaluated by the crowdsourcing service 121 by comparing them with the known, definitive results of such gold HITs to determine whether the workers 140 are generating quality results. Consequently, the communication 181, from the crowdsourcing service 121, to the qualified workers 140, illustrates the provision of both HITs 182, which the qualified workers 140 have been qualified to perform, as well as the provision of gold HITs 183 for monitoring purposes. As will be described in further detail below, other monitoring mechanisms can likewise be utilized to detect poor quality results being generated by one or more of the qualified workers 140.

According to one aspect, if the crowdsourcing service 121 detects that one or more of the qualified workers 140 is providing poor quality results, then such a worker can be transitioned to the conditionally qualified workers 150, such as the exemplary conditionally qualified workers 151 and 152, as illustrated by the transition 189. The determination that one of the qualified workers 140 is providing poor quality results can be made in accordance with a minimum quality threshold, such as can be established by a task owner, the crowdsourcing service 121, or combinations thereof, or it can be based on, and triggered by, one or more results provided by such a worker to gold HITs, such as one of the gold HITs 183, that were not in accordance with the definitive results associated with such gold HITs.

Rather than labeling workers whose results fail to meet a minimum quality threshold as “spammers”, or otherwise discarding them or disqualifying them, the transition 189 to the conditionally qualified workers 150 can enable such workers to be retrained, or to otherwise improve the quality of the results that such workers provide to the HITs assigned to them. For example, according to one aspect, a conditionally qualified worker, such as one of the conditionally qualified workers 150, can transition back to being a qualified worker, such as one of the qualified workers 140, merely through the passage of time, diagrammatically illustrated by the clock 171. More colloquially, such a passage of time can be an enforced “break” from the performance of intelligence tasks, thereby enabling such a worker to undertake a mental respite. Should the decrease in the quality of the results being provided by such a worker be due to worker fatigue, an enforced delay can aid the worker in improving the quality of the results they provide to the HITs assigned to them.

As another example, according to another aspect, a conditionally qualified worker, such as one of the conditionally qualified workers 150, can transition back to being a qualified worker, such as one of the qualified workers 140, through additional training, which can be provided with reference to the gold HITs 192, provided by the communication 191 from the crowdsourcing service 121. More specifically, the additional training can be required of the conditionally qualified workers 150, such as during the period of time during which those workers are prevented from performing useful work. According to one aspect, such offline training can be specifically targeted to those nuances that the worker appears to have misunderstood, based upon the HIT results provided by such a worker to the gold HITs 183, as compared with the definitive answers of such gold HITs 183 and with reference to the minimum quality thresholds established. For example, returning to the above example, if a worker has incorrectly classified “not relevant” webpages as being “partially relevant”, then the gold HITs 192 provided to such a worker, to train such a worker on the distinction between “not relevant” webpages and “partially relevant” webpages, can comprise webpages that are predominantly either “not relevant” or “partially relevant”. According to one aspect, however, other nuances can, additionally, be tested to avoid the worker anticipating the proper result, as opposed to learning from the training. The results 193 provided by the worker in response to the training can be analyzed, such as by the crowdsourcing service 121, to determine whether the worker displays evidence of having learned the nuance, such as by providing HIT results 193 whose quality is above a minimum quality threshold.

Once one of the conditionally qualified workers 150 has been aided to improve the quality of the HIT results provided by such a worker, that worker can be transitioned back to the qualified workers, as illustrated by the transition 199. A conditionally qualified worker who fails to undertake the aid offered to improve the quality of the HIT results provided by such a worker can, according to one aspect, be disqualified and returned to the pool of available workers 130. In addition, although not specifically illustrated by the system 100 of FIG. 1, workers can be aided to improve the quality of their HIT results through online training when the quality of the results they were providing was still above the thresholds at which such workers would have been transitioned to the conditionally qualified workers 150, but was otherwise deemed to be suboptimal and capable of being improved. In such online training, described in detail below, specific aid can be offered depending on the nature of the deficiency in the quality of the HIT results provided by workers, such as the specific nuances that an individual worker appears to be addressing suboptimally.

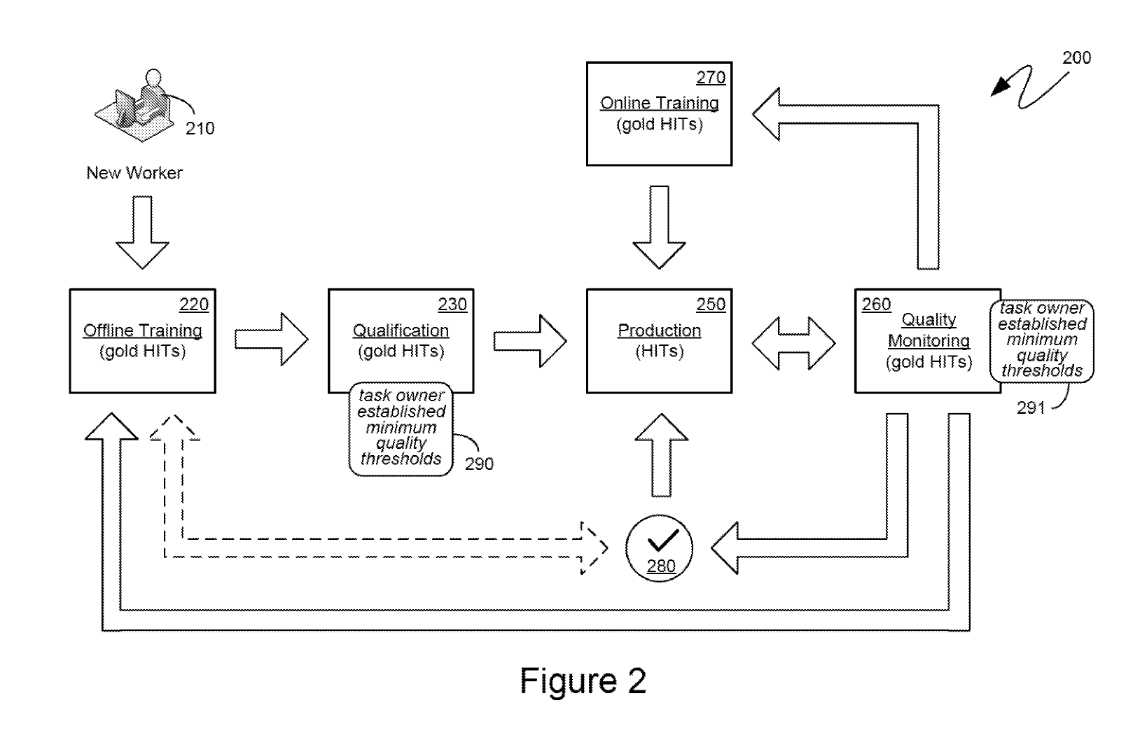

Turning to FIG. 2, the system 200 shown therein illustrates various components and mechanisms with which workers can interact as part of the aiding of such workers to improve the quality of the HIT results generated by such workers. The components of the system 200 of FIG. 2 can be components of a single HITapp, components that comprise computer-executable instructions of a HITapp operating in combination with computer-executable instructions executing at the crowdsourcing service, components of the crowdsourcing service, or combinations thereof. Initially, as illustrated in FIG. 2, a new worker 210 can interact with a offline training component 220 in order to be qualified to perform HITs through a HITapp that the worker 210 selected. More specifically, and as indicated previously, workers can select the sorts of tasks that they will perform by selecting a specific HITapp, from among the multiple HITapps made available by a crowdsourcing platform and which workers can browse prior to selecting a specific HITapp. Upon selecting a specific HITapp, a worker, such as exemplary new worker 210, can be directed to interact with the offline training component 220. As utilized herein, the term “offline” means that that an activity is being performed outside of the performance of useful work, as defined above. Thus, the offline training component 220 is “offline” because a worker engaging with such a component is not performing useful work, nor is the worker's interaction with the component integrated with, or interleaved with, the performance of useful work. The term “offline” as utilized herein does not refer to whether network communications are utilized. To the contrary, the aspects described herein can be implemented through continuous network communications, including during periods where workers are described as interacting with, or participating in, “offline” training. The offline training component 220 can train the new worker 210 to provide quality results to the sorts of HITs that the worker will be assigned through the selected HITapp. Typically, such training will utilize gold HITs by first providing such gold HITs to the new worker 210, and then subsequently providing the definitive answers to such gold HITs and utilizing such definitive answers to either verify that the new worker 210 has correctly answered a gold HIT, or to correct incorrect results provided by the new worker 210 and explain to the new worker 210 the reasons why the definitive answer is deemed to be correct.

According to one aspect, the offline training component 220 can monitor the responses provided by the new worker 210 to the gold HITs and can dynamically modify the training provided to emphasize nuances with which the new worker 210 appears to be struggling. For example, returning to the above example of tasks in which a worker is asked to evaluate an association between a webpage and a particular search query, the offline training component 220 can detect that, for example, the new worker 210 often mistakes “somewhat relevant” webpages as “not relevant”. In such an aspect, the offline training component 220 can increase the gold HITs provided to emphasize the distinction between “somewhat relevant” webpages and “not relevant” ones.

Upon completing the training provided by the offline training component 220, the new worker 210 can interact with a qualification component 230 that can evaluate the worker's ability to provide quality results to the sorts of tasks the worker will be expected to answer through the HITapp that was selected by the worker. More specifically, as an option, a task owner can be provided with the ability to require workers, to whom the individual HITs of the task will be assigned, to first be qualified in accordance with quality thresholds that can be selected by the task owner, the crowdsourcing service, or combinations thereof. To the extent that such an option is not selected by the task owner, a new worker, such as the new worker 210, need not interact with the offline training component 220, nor the qualification component 230 and can, instead, directly interact with the production component 250. However, should the task owner select such an option, the worker can interact with the components as described herein. As with the offline training component 220, the qualification component 230 can utilize gold HITs provided by the task owner to perform the qualification. More specifically, the qualification component 230 can provide, to the new worker 210, a series of gold HITs, and can then compare the results generated by the new worker 210, in response to such gold HITs, to the definitive answers associated with such gold HITs. The qualification component 230 can then reference task owner established minimum quality thresholds 290 to determine whether the new worker 210 has exceeded such minimum quality thresholds 290 and should be qualified.

According to one aspect, the minimum quality thresholds 290 can be an overall metric that can, for example, be based simply upon the gold HITs, provided by the qualification component 230 to the new worker 210 as a qualification test, that the new worker 210 performed correctly. For example, the minimum quality thresholds 290 can specify a minimum percentage of the gold HITs, provided by the qualification component 230, that the new worker 210 is expected to perform correctly. As another example, the minimum quality thresholds 290 can specify a minimum quantity of the gold HITs that the new worker 210 is expected to perform correctly in order to be qualified. A new worker, such as the new worker 210, exceeding such minimum quality thresholds 290, and performing a greater quantity of gold HITs correctly, can be qualified by the qualification components 230, and can proceed to interact with the production components 250, such as will be described in detail below. A new worker that does not exceed the minimum quality thresholds 290 can, according to one aspect, be offered retraining and requalification, such as via the offline training component 210 and the qualification component 230.

According to another aspect, the minimum quality thresholds 290 can comprise separately established thresholds for different nuances of the tasks provided through the HITapp that the new worker 210 selected. For example, returning to the above example, the minimum quality thresholds 290 can individually and separately specify one minimum quality threshold for correctly providing results to HITs in which the new worker 210 must distinguish between “not relevant” and “somewhat relevant” webpages, and another, separate minimum quality threshold for correctly providing results to HITs in which the new worker 210 must distinguish between “somewhat relevant” and “very relevant” webpages. As above, each individual minimum quality threshold, for each specific nuance, can be based on the gold HITs, provided by the qualification component 230, that the new worker 210 performed correctly. As such, the minimum quality thresholds 290, for each specific nuance, can be based on an aggregate quantity of gold HITs, directed to such a nuance, that the new worker 210 performed correctly, a percentage of gold HITs, directed to such nuance, that the new worker 210 performed correctly, or other like quantifications of the new worker's ability to provide quality results to gold HITs directed to the enumerated nuances. As before, a new worker, such as the new worker 210, exceeding such minimum quality thresholds 290, can be qualified by the qualification component 230, and can proceed to interact with the production component 250, while a new worker that does not exceed the minimum quality thresholds 290 can, according to one aspect, be offered retraining and requalification, such as via the offline training component 210 and the qualification component 230, or can simply be not qualified.

If the new worker 210 is qualified by the qualification component 230, the worker can proceed to interact with the production component 250, where the worker can be provided with HITs, such as through the HITapp that the worker selected, and can provide results thereto. Since the HITs that the worker receives from the production component 250 can be HITs for which definitive results are not already known, the results generated by and provided by the worker can be “useful work”, in that they provide results to HITs that were not previously performed.

A quality monitoring component 260 can interact with the production component 250, and the worker, to randomly and occasionally insert gold HITs among the HITs provided by the production component 250. Since the worker would not be aware that such gold HITs already had definitive results already associated with them, the worker would provide results the same manner as the worker was providing to the HITs provided by the production component 250. The quality monitoring component 260 can then compare the results the worker provided to the gold HITs to the definitive answers associated with such gold HITs, and can, thereby, monitor the quality of the work being performed by the worker in interacting with production component 250. According to another aspect, the monitoring of the quality the results being provided by a worker interacting with the production component 250 need not be limited to the periodic checking enumerated above. Instead, the quality monitoring component 260 can utilize other mechanisms for monitoring the quality of the results being generated by a worker in interacting with the production component 250. For example, the quality monitoring component 260 can utilize behavioral monitoring to detect results generated by the worker, in the worker's interaction with the production component 250, for which the worker did not behave in a manner indicative of the provision of quality results to the HITs being provided by the production component 250. As another example, the quality monitoring component 260 can utilize loyalty monitoring to detect how long a specific worker has been providing results to HITs through the production component 250, and can take such information into account in estimating a quality of the results being provided by the worker.

Irrespective of the mechanism utilized by the quality monitoring component 260, once metrics for the quality of the results being provided by a worker, for HITs provided to such a worker through the production component 250, are available to the quality monitoring component 260, the quality monitoring component 260 can compare such metrics to task owner established minimum quality thresholds 291. The task owner established minimum quality thresholds 291 can be the same as the task owner established minimum quality thresholds 290, or they can be independently established. For example, a task owner may have more stringent quality requirements to qualify worker in the first place, and might relax those quality requirements for workers that have already been qualified and are already providing “useful work” in order to, for example, give the benefit of the doubt to experienced workers. As before, the minimum quality thresholds 291 can comprise an overall quality threshold, or they can comprise individual minimum quality thresholds for discrete nuances of the tasks being performed. In the latter case, the quality monitoring component 260 can collect quality metrics that can individually track a worker's quality with respect to those discrete nuances.

If the quality monitoring component 260 determines that a quality of HIT results provided by a worker via the production component 250 are below the minimum quality thresholds 291, the quality monitoring component 260 can take action to aid such a worker to improve the quality of the results they are generating. According to one aspect, one action that the quality monitoring component 260 can take can be to enforce a rest period, graphically illustrated by the clock 280, during which the worker would not be allowed to interface with the production component 250 and receive HITs therefrom. Such a rest period can apply only to the specific HITapp with which the worker was interacting, and through which the worker was receiving HITs when the quality monitoring component 260 determined that the quality the results being generated by such a worker were below the minimum quality thresholds 291. Alternatively, such a rest period can apply to any HITapp available through the crowdsourcing service. A rest period can be a predetermined amount of time sufficient to allow the worker to overcome any temporary issues that may be temporarily causing the worker to provide poor quality results. According to one aspect, the rest period can be a couple of hours, such as one hour, two hours, four hours, eight hours, twelve hours, or a twenty-four hour period. By enforcing such a rest period, the quality monitoring component 260 can attempt to address poor quality results being generated by the worker due to, for example, worker fatigue or other like temporary issues. Once such an enforced rest period is over, the worker can be allowed to resume interfacing with the production component 250, receiving HITs therefrom, and providing HIT results thereto.

According to another aspect, a different action that the quality monitoring component 260 can take can be to require that the worker, in addition to being prevented from interfacing with the production component 250 for a defined period of time, also utilize the offline training component 220 during that period of time, as represented by the clock 280. A worker would then be allowed to interface with the production component 250 upon completion of the enforced rest. And upon verification that, during the enforced rest period, the worker interacted with the online training component 220, such as for a minimum amount of time, or for a minimum quantity of training HITs.

In certain situations, the quality identified by the quality monitoring component 260 need not be below the task owner established minimum quality thresholds 291, but can nevertheless indicate suboptimal quality output. For example, the quality monitoring component 260 can detect that a worker is providing lower quality results with respect to specific nuances of the task whose HITs the worker is receiving via the production component 250. In such an instance, the quality monitoring component 260 need not prevent the worker from continuing to interface with the production component 250, since the worker does meet the minimum quality thresholds 291, but can nevertheless provide aid to the worker in an effort to further improve the quality of the results being provided by such worker. According to one aspect, the quality monitoring component 260 can cause of the worker to interface with an online training component 270 to receive training to improve the quality of the HIT results being generated by the worker, specifically with respect to those nuances that the quality monitoring component 260 identified as being provided with suboptimal results from the worker. The online training component 270 can provide generalized training, if no information is available regarding specific nuances, or, conversely, if the quality monitoring component 260 has identified specific nuances, then the online training component 270 can provide online training on specifically those nuances. In a manner analogous to that utilized by the offline training component 220, the online training component 270 can utilize gold HITs to train the worker in order to improve the quality of the results being provided by such a worker. More specifically, the online training component 270 can provide, to the worker, gold HITs for the worker to perform and return a corresponding result. The online training component 270 can then analyze the results in comparison with the definitive results associated with the gold HITs, and can provide feedback to the worker to aid the worker in understanding, for example, why a result provided by the worker was suboptimal. According to one aspect, to the extent that the online training component 270 provides training that is specifically directed to those nuances that the quality monitoring component 260 identified as being associated with results that do not meet the minimum quality thresholds, the online training component 270 can those gold HITs that are directed to such nuances. Additionally, to avoid the possibility that the worker anticipates the nature of the HITs, thereby decreasing the effectiveness of the training, the online training component 270 can interleave gold HITs directed to other nuances even while providing nuance-specific online training.

The worker's interaction with the online training component 270 can be interleaved with the worker's interaction with the production component 250 in much the same manner as the worker's interaction with the quality monitoring component 260, such as when the worker is provided with gold hits by the quality monitoring component 260, can be interleaved with the worker's interaction with the production component 250. The quality monitoring component 260 can then continue to monitor the quality of the results being provided by such a worker and, as the worker's interaction with online training component 270 increases the quality of the results being provided by the worker, equality monitoring component 260 can discontinue the worker's interaction with the online training components 270 and allow the worker to return to interacting solely with the production component 250 and the quality monitoring component 260.

According to one aspect, the manner in which the quality monitoring component 260 responds to a determination that the results being provided by a worker do not meet the minimum quality thresholds 291 can be dependent upon factors that include the prior history or performance of such a worker. For example, if the worker has been interacting with the production component 250 for an extended period of time, quality monitoring component 260 can, upon detecting that the results being provided by the worker do not meet the minimum quality thresholds 291, first try to improve the quality of the results being provided by the worker by enforcing a rest period, such as that represented by the clock 280. If, subsequently, the results provided by the worker again fail to meet the minimum quality thresholds 291, the quality monitoring component 260 can again enforce a rest period, such as that represented by the clock 280, however, in such a subsequent case, the quality monitoring component 260 can, further require that, during such an enforced rest period, the worker also interact with the offline training component 220, and the quality monitoring component 260 can enable the worker to return to interacting with the production component 250 only after the completion of both such actions. As yet another example, the quality monitoring component 260 can immediately disqualify a worker, without enforcing a rest period, and without requiring the worker to interface with the offline training component 220, if the quality monitoring component 260 determines that that worker has had the quality of their results drop below the minimum quality thresholds 291 too many times within the recent past, such as within a prior predetermined period of time. For example, the quality monitoring component 260 can automatically disqualify a worker if the quality of the results provided by such a worker have dropped below the minimum quality thresholds 291 three separate times within a twenty-four hour period. In such an instance, the worker would be directed to the offline training component 220, and would have to re-qualify, such as via the qualification component 230, in the same manner as the new worker 210, described in detail above.

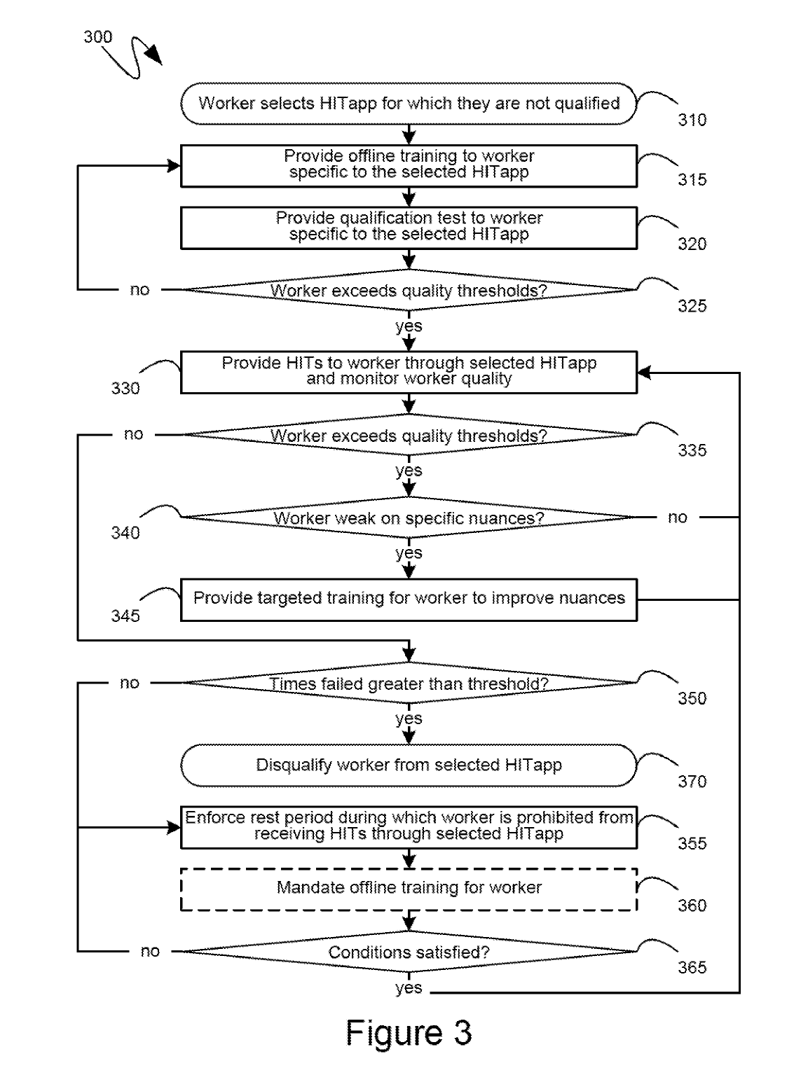

Turning to FIG. 3, the flow diagram 300 shown therein illustrates an exemplary series of steps by which the quality of the results provided by a worker can be improved through mechanisms implemented by a crowdsourcing service, and the worker can be aided rather than being labeled a “spammer” and being removed. Initially, at step 310, a worker can select a HITapp through which such a worker desires to perform HITs. For purposes of the present description, the HITapp can be a HITapp for which the worker has either not previously been qualified, or has previously qualified, but was then subsequently disqualified. In other words the HITapp selected at step 310 can be a HITapp for which the worker selecting such a HITapp is not currently qualified. Processing can proceed to step 315, where the worker can be provided with offline training for the selected HITapp. As indicated previously, such training can equally emphasize multiple or all nuances in the performance of tasks through the selected HITapp, to the extent that such nuances exist, and can otherwise provide generalized training, such as opposed to specific training on a specific nuance of a task performed through the selected HITapp. Once such training is complete, at step 315, processing can proceed to step 320, where the worker can be tested, such as through the provision of gold HITs, in order to determine whether the worker is qualified to perform HITs through the selected HITapp. The worker can provide responses to the gold HITs that comprise the qualification test, at step 320, and, at step 325, an analysis can be performed by comparing the results provided by the worker to the definitive answers associated with the gold HITs that were presented to the worker. Such an analysis, at step 325, can be compared to minimum quality thresholds, such as minimum quality thresholds established by a task owner, in order to determine whether the worker exceeded such minimum quality thresholds. As indicated previously, the analysis, at step 325, can be performed on a per-nuance basis, where the quality of the results provided to the HITs comprising the qualification test, administered at step 320, can be evaluated discreetly for one or more different nuances of the tasks associated with the selected HITapp.

If, at step 325, is determined that the worker did not exceed the established quality thresholds, processing can return to step 315, and the worker can be provided with additional off-line training. Optionally, information can be provided to the offline training such that, at a subsequent performance of step 315, the offline training can provide targeted training to the worker to improve, for example, the worker's understanding of specific nuances, or other like targeted aspects of the worker's performance of HITs provided through the selected HITapp. Processing can then again return to step 320, and the worker can be provided another qualification test. Although illustrated in the exemplary flow diagram 300 of FIG. 3 as a continuous loop, the performance of such additional training, as part of a subsequent performance of step 315, followed by a subsequent administering of a qualification test, at step 320, can be performed a limited number of times before a determination can be made that the worker will not be qualified and no further qualification tests will be provided. For example, the worker can be provided with one opportunity to improve the quality of the results being generated by such a worker, so as to exceed the quality thresholds, as determined at step 325. In such an example, the qualification test, at step 320, can be performed a maximum of two times.

Returning back to step 325, if it is determined that the worker exceeds the minimum quality thresholds, then the worker can be qualified, and processing can proceed to step 330, and HITs can be provided to the worker through the selected HITapp. As described in detail above, step 330 can entail the performance of useful work, through the selected HITapp, by a worker. Additionally, as also described above, the quality of the results provided by the worker, at step 330, can be monitored. Such monitoring can utilize gold HITs, comparing the results provided by the user to such gold HITs to the definitive answers associated with such gold HITs, or such monitoring can utilize other mechanisms such as, for example, behavioral monitoring, historical monitoring, loyalty monitoring and other like monitoring by which the quality of results provided by a user can be ascertained. At step 335, as part of the monitoring being performed at step 330, a determination can be made as to whether the quality of the results being provided by the worker to the HITs performed by the worker through the selected HITapp exceed minimum quality thresholds.

If, at step 335, is determined that the quality of the results being provided by the worker do not exceed minimum quality thresholds, the worker can be aided to improve the quality of the results they are providing. For example, as described in detail above, a rest period can be enforced by preventing the worker from receiving any further HITs for a predefined period of time. As another example, as also described in detail above, such an enforced rest period can be combined with the requirement to perform additional offline training. According to one aspect, a determination, at step 350, can initially determine whether the worker's failure to provide results that exceed quality thresholds, as determined at step 335, has occurred more than a threshold number of times, or a threshold number of times during a predefined period of time. If the determination, at step 350, indicates that such a failure has occurred too many times, then the worker can be disqualified, at step 370 and the relevant processing can end there. Conversely, if the determination, at step 350, finds that the quality of the results provided by the worker have not fallen below the quality thresholds too many times, a rest period can be enforced, and the processing can proceed to step 355 and enforce such a rest period, where the worker can be prevented from receiving HITs through the selected HITapp for a predetermined period of time, such as a couple of hours or one day. Optionally, as indicated, coincidentally with the enforcement of the rest period, at step 355, the worker can be required to undertake offline training. Such a requirement is indicated by step 360, which is illustrated in dashed lines in the exemplary flow diagram 300 of FIG. 3 to illustrate that it is an optional step. Processing can then proceed with step 365, where a determination can be made as to whether the conditions, such as the enforced rest period, or the mandated offline training, or combinations thereof, have been satisfied. If, at step 365, it is determined that such conditions have not yet been satisfied, then processing can return back to step 355. Conversely, if, at step 365, it is determined that those conditions are satisfied, then processing can return to step 330 and the worker can proceed to perform useful work, such as detailed above.

Returning back to the determination, at step 335, if it is determined that the quality of the results being provided by the worker do exceed the quality thresholds, than a subsequent check can be performed, such as at step 340, to determine whether any of the worker's results are suboptimal, even though they exceed the minimum quality thresholds, as determined at step 335. If, at step 340, it is determined that the quality of the results being provided by the worker appear to be optimal, then processing can return to step 330 and the worker can continue to perform useful work, such as detailed above. Conversely, if, at step 340, it is determined that the results the workers generating appear to be suboptimal with response to one or more nuances of the task, then processing can proceed to step 345, and online training can be provided to the worker to aid the worker in improving the quality of the results being provided, by such a worker, to the HITs the worker performs through the selected HITapp. More specifically, and as indicated previously, such online training, at step 345, can receive information regarding specific nuances in which the worker appears to be deficient in providing results to tasks through the selected HITapp. Utilizing such information, online training, at step 345, can select gold HITs directed to those nuances in order to focus the training provided to the worker. The performance, of the online training, at step 345, can be interleaved with the performance of useful work, at step 330. Or it can be a discrete step that, upon completion of the online training, at step 345, processing can return to step 330.

According to one aspect, to encourage workers to undertake the above-described training and qualification steps, monetary or other compensatory rewards or incentives can be offered. As will be recognized by those skilled in the art, traditionally workers in a crowdsourcing environment are only compensated for the useful work they perform. Consequently, the above-described training and qualification would, under such a traditional model, be expected to be performed by a worker for free. However, workers may be hesitant to invest their time and resources into such training and qualification without any compensation in return. Consequently, according to one aspect, workers can be compensated for undertaking some or all of the above-described training and qualification. For example, workers can be provided a monetary bonus, or other like lump-sum reward upon being qualified to perform useful work. As another example, workers can be compensated for undertaking some or all of the above-described training and qualification as an increase in the compensation they receive while performing useful work. For example, workers can receive added compensation for an initial amount of tasks that they perform as compensation for having participated in the training and qualification steps. Thus, in such an example, a worker receiving a dollar for each task performed can, for example, received two dollars for the first fifty tasks, thereby resulting in a payment of fifty dollars as compensation for the user for having undertaken the training and qualification steps. As yet another example, workers can receive increased compensation as they perform a greater quantity of tasks, to encourage workers to continue to participate in online training and other like mechanisms, described in detail above, by which already qualified workers are aided in improving the quality of their results. In such another example, a worker can receive a dollar for each task performed up to, for example, the first one hundred tasks. For a subsequent hundred tasks, the worker can be paid one dollar and fifty cents. For each task, above a total of two hundred tasks performed by the worker, the worker can be paid two dollars, for example. In such a manner, workers can be compensated and encouraged to both participate in the training and qualification processes to become qualified workers, and then to participate in the subsequent training and other quality aids offered to qualified workers to improve the quality of the HIT

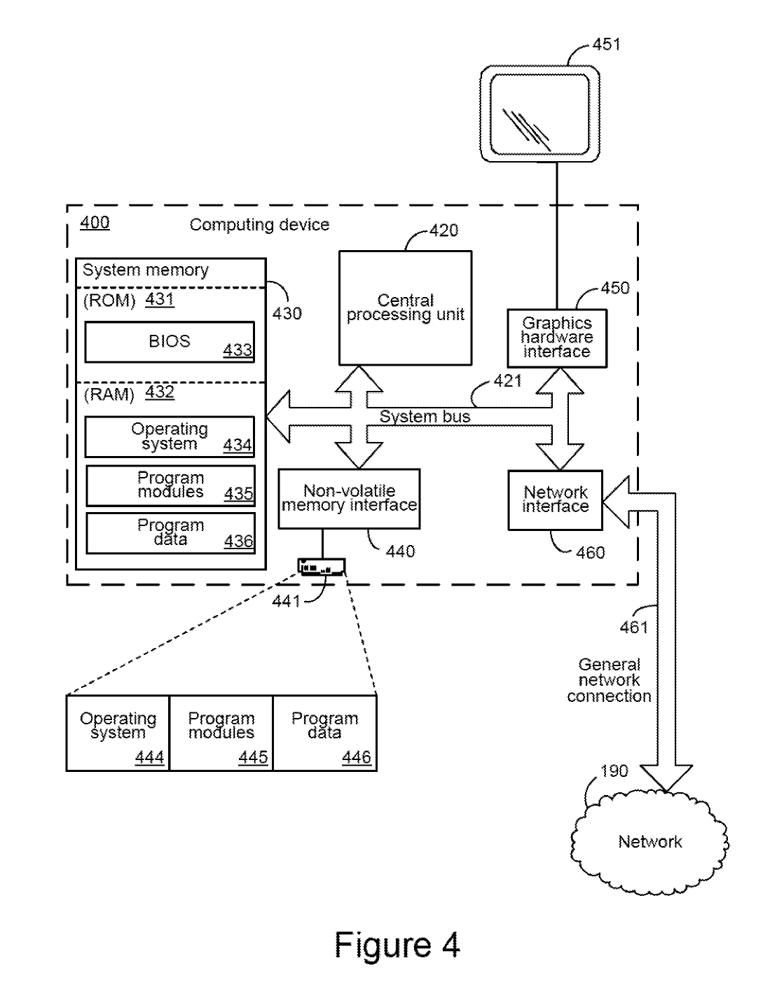

Turning to FIG. 4, an exemplary computing device 400 is illustrated which can perform some or all of the mechanisms and actions described above. The exemplary computing device 400 can include, but is not limited to, one or more central processing units (CPUs) 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. The computing device 400 can optionally include graphics hardware, including, but not limited to, a graphics hardware interface 450 and a display device 451, which can include display devices capable of receiving touch-based user input, such as a touch-sensitive, or multi-touch capable, display device. Depending on the specific physical implementation, one or more of the CPUs 420, the system memory 430 and other components of the computing device 400 can be physically co-located, such as on a single chip. In such a case, some or all of the system bus 421 can be nothing more than silicon pathways within a single chip structure and its illustration in FIG. 4 can be nothing more than notational convenience for the purpose of illustration.

The computing device 400 also typically includes computer readable media, which can include any available media that can be accessed by computing device 400 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. Computer storage media, however, does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computing device 400, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, other program modules 435, and program data 436.

The computing device 400 may also include other removable/non-removable, volatile/nonvolatile computer storage media. By way of example only, FIG. 4 illustrates a hard disk drive 441 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 441 is typically connected to the system bus 421 through a non-volatile memory interface such as interface 440.

The drives and their associated computer storage media discussed above and illustrated in FIG. 4, provide storage of computer readable instructions, data structures, program modules and other data for the computing device 400. In FIG. 4, for example, hard disk drive 441 is illustrated as storing operating system 444, other program modules 445, and program data 446. Note that these components can either be the same as or different from operating system 434, other program modules 435 and program data 436. Operating system 444, other program modules 445 and program data 446 are given different numbers hereto illustrate that, at a minimum, they are different copies.

The computing device 400 may operate in a networked environment using logical connections to one or more remote computers. The computing device 400 is illustrated as being connected to the general network connection 461 through a network interface or adapter 460, which is, in turn, connected to the system bus 421. In a networked environment, program modules depicted relative to the computing device 400, or portions or peripherals thereof, may be stored in the memory of one or more other computing devices that are communicatively coupled to the computing device 400 through the general network connection 461. It will be appreciated that the network connections shown are exemplary and other means of establishing a communications link between computing devices may be used.

Although described as a single physical device, the exemplary computing device 400 can be a virtual computing device, in which case the functionality of the above-described physical components, such as the CPU 420, the system memory 430, the network interface 460, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where the exemplary computing device 400 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executed within the construct of another virtual computing device. The term “computing device”, therefore, as utilized herein, means either a physical computing device or a virtualized computing environment, including a virtual computing device, within which computer-executable instructions can be executed in a manner consistent with their execution by a physical computing device. Similarly, terms referring to physical components of the computing device, as utilized herein, mean either those physical components or virtualizations thereof performing the same or equivalent functions.

The descriptions above include, as a first example, a computing device for improving quality of results to intelligence tasks, the results being generated by a human worker within a crowdsourcing system, the computing device comprising one or more processing units and computer-readable media comprising computer-executable instructions that, when executed by the processing units, cause the computing device to perform steps comprising: detecting that the quality of the results generated by the human worker are below a predetermined quality threshold; preventing, for a predetermined and finite period of time, the human worker from generating further results to intelligence tasks of a same overall task as the intelligence tasks to which the human worker generated the results that were detected to be below the predetermined quality threshold, the preventing being triggered by the detecting of the quality of the results being below the predetermined quality threshold; enabling the human worker to again perform useful work by receiving intelligence tasks and providing results thereto only in response an expiration of the predetermined and finite period of time; detecting that the results generated by the human worker exceed the predetermined quality threshold but that the results generated by the human worker directed to at least one specific nuance of the intelligence tasks are of lesser quality than the results generated by the human worker directed other specific nuances of the intelligence tasks; and providing online training, while the human worker remains enabled to perform useful work, the online training being directed to the at least one specific nuance of the intelligence tasks, the providing being triggered by the detecting of results directed to the at least one specific nuance being of lesser quality than the results directed to the other specific nuances

A second example is the computing device of the first example, wherein the detecting of the quality of the results being below the predetermined quality threshold comprises estimating the quality of the results based upon a comparison between results to gold intelligence tasks generated by the human worker and predetermined definitive correct results corresponding to the gold intelligence tasks.

A third example is the computing device of the first example, comprising further computer-executable instructions that, when executed by the processing units, cause the computing device to perform further steps comprising mandating that the human worker perform offline training during the predetermined and finite period of time; wherein the enabling is performed only in response to both the expiration of the predetermined and finite period of time and the human worker's completion of the mandated offline training.

A fourth example is the computing device of the third example, wherein the mandating is based on a quantity of previous times the quality of the results generated by the human worker were detected to be below the predetermined quality threshold.

A fifth example is the computing device of the first example, comprising further computer-executable instructions that, when executed by the processing units, cause the computing device to perform further steps comprising disqualifying the human worker from again performing, without subsequent qualification, useful work by receiving the intelligence tasks and providing the results thereto, the disqualifying being conditioned upon a quantity of previous times the quality of the results generated by the human worker were detected to be below the predetermined quality threshold exceeding a predetermined quantity.

A sixth example is the computing device of the first example, comprising further computer-executable instructions that, when executed by the processing units, cause the computing device to perform further steps comprising: providing training to the human worker prior to providing qualification intelligence tasks to the human worker; and qualifying the human worker to perform the useful work only if results generated by the human worker in response to the qualification intelligence tasks are of greater quality than predetermined qualification quality thresholds.

A seventh example is the computing device of the sixth example, wherein the human worker is provided compensation for completing the training and the qualification.

An eighth example is the computing device of the sixth example, wherein the compensation comprises increased payments for the performance of the useful work.

A ninth example is a computing device for improving quality of results to intelligence tasks, the results being generated by a human worker within a crowdsourcing system, the computing device comprising one or more processing units and computer-readable media comprising computer-executable instructions that, when executed by the processing units, cause the computing device to perform steps comprising: providing training to the human worker prior to providing qualification intelligence tasks to the human worker; qualifying the human worker to perform useful work, comprising generating the results to the intelligence tasks, only if results generated by the human worker in response to the qualification intelligence tasks are of greater quality than predetermined qualification quality thresholds; compensating the human worker for the performance of the useful work; and compensating, in addition to the compensation for the performance of the useful work, the human worker for completing the training and the qualification.

An tenth example is the computing device of the ninth example, wherein the compensating the human worker for completing the training and the qualification comprises increasing the compensating the human worker for the performance of a discrete portion of the useful work.

An eleventh example is the computing device of the ninth example, wherein the compensating the human worker for completing the training and the qualification comprises progressively increasing the compensating the human worker for the performance of discrete portions of the useful work, each discrete portion being associated with progressively increased compensation.

A twelfth example is the computing device of the ninth example, comprising further computer-executable instructions that, when executed by the processing units, cause the computing device to perform further steps comprising: detecting that the quality of the results generated by the human worker are below a predetermined quality threshold; preventing, for a predetermined and finite period of time, the human worker from generating further results to intelligence tasks of a same overall task as the intelligence tasks to which the human worker generated the results that were detected to be below the predetermined quality threshold, the preventing being triggered by the detecting of the quality of the results being below the predetermined quality threshold; enabling the human worker to again perform useful work only in response to an expiration of the predetermined and finite period of time; detecting that the results generated by the human worker exceed the predetermined quality threshold but that the results generated by the human worker directed to at least one specific nuance of the intelligence tasks are of lesser quality than the results generated by the human worker directed other specific nuances of the intelligence tasks; and providing online training, while the human worker remains enabled to perform useful work, the online training being directed to the at least one specific nuance of the intelligence tasks, the providing being triggered by the detecting of results directed to the at least one specific nuance being of lesser quality than the results directed to the other specific nuances.

A thirteenth example is a method for improving quality of results to intelligence tasks, the results being generated by a human worker within a crowdsourcing system, the method comprising the steps of: detecting that the quality of the results generated by the human worker are below a predetermined quality threshold; preventing, for a predetermined and finite period of time, the human worker from generating further results to intelligence tasks of a same overall task as the intelligence tasks to which the human worker generated the results that were detected to be below the predetermined quality threshold, the preventing being triggered by the detecting of the quality of the results being below the predetermined quality threshold; enabling the human worker to again perform useful work by receiving intelligence tasks and providing results thereto only in response an expiration of the predetermined and finite period of time; detecting that the results generated by the human worker exceed the predetermined quality threshold but that the results generated by the human worker directed to at least one specific nuance of the intelligence tasks are of lesser quality than the results generated by the human worker directed other specific nuances of the intelligence tasks; and providing online training, while the human worker remains enabled to perform useful work, the online training being directed to the at least one specific nuance of the intelligence tasks, the providing being triggered by the detecting of results directed to the at least one specific nuance being of lesser quality than the results directed to the other specific nuances.

A fourteenth example is the method of the thirteenth example, wherein the detecting of the quality of the results being below the predetermined quality threshold comprises estimating the quality of the results based upon a comparison between results to gold intelligence tasks generated by the human worker and predetermined definitive correct results corresponding to the gold intelligence tasks.

A fifteenth example is the method of the thirteenth example, comprising further computer-executable instructions that, when executed by the processing units, cause the computing device to perform further steps comprising mandating that the human worker perform offline training during the predetermined and finite period of time; wherein the enabling is performed only in response to both the expiration of the predetermined and finite period of time and the human worker's completion of the mandated offline training.

A sixteenth example is the method of the fifteenth example, wherein the mandating is based on a quantity of previous times the quality of the results generated by the human worker were detected to be below the predetermined quality threshold.

A seventeenth example is the method of the thirteenth example, further comprising the steps of disqualifying the human worker from again performing, without subsequent qualification, useful work by receiving the intelligence tasks and providing the results thereto, the disqualifying being conditioned upon a quantity of previous times the quality of the results generated by the human worker were detected to be below the predetermined quality threshold exceeding a predetermined quantity.

An eighteenth example is the method of the thirteenth example, further comprising the steps of: providing training to the human worker prior to providing qualification intelligence tasks to the human worker; and qualifying the human worker to perform the useful work only if results generated by the human worker in response to the qualification intelligence tasks are of greater quality than predetermined qualification quality thresholds.

A nineteenth example is the method of the eighteenth example, wherein the human worker is provided compensation for completing the training and the qualification.

A twentieth example is the method of the eighteenth example, wherein the compensation comprises increased payments for the performance of the useful work.

As can be seen from the above descriptions, mechanisms for automatically aiding human workers in the performance of intelligence tasks in a crowdsourcing system have been presented. In view of the many possible variations of the subject matter described herein, we claim as our invention all such embodiments as may come within the scope of the following claims and equivalents thereto.

We claim:

1. A computing device for improving quality of results to intelligence tasks, the results being generated by a human worker within a crowdsourcing system, the computing device comprising one or more processing units and computer-readable media comprising computer-executable instructions that, when executed by the processing units, cause the computing device to perform steps comprising:
detecting that the quality of the results generated by the human worker are below a predetermined quality threshold;
preventing, for a predetermined and finite period of time, the human worker from generating further results to intelligence tasks of a same overall task as the intelligence tasks to which the human worker generated the results that were detected to be below the predetermined quality threshold, the preventing being triggered by the detecting of the quality of the results being below the predetermined quality threshold;
enabling the human worker to again perform useful work by receiving intelligence tasks and providing results thereto only in response to an expiration of the predetermined and finite period of time;
detecting that the results generated by the human worker exceed the predetermined quality threshold but that the results generated by the human worker directed to at least one specific nuance of the intelligence tasks are of lesser quality than the results generated by the human worker directed other specific nuances of the intelligence tasks; and
providing online training, while the human worker remains enabled to perform useful work, the online training being directed to the at least one specific nuance of the intelligence tasks, the providing being triggered by the detecting of results directed to the at least one specific nuance being of lesser quality than the results directed to the other specific nuances.

2. The computing device of claim 1, wherein the detecting of the quality of the results being below the predetermined quality threshold comprises estimating the quality of the results based upon a comparison between results to gold intelligence tasks generated by the human worker and predetermined definitive correct results corresponding to the gold intelligence tasks.

3. The computing device of claim 1, comprising further computer-executable instructions that, when executed by the processing units, cause the computing device to perform further steps comprising mandating that the human worker perform offline training during the predetermined and finite period of time; wherein the enabling is performed only in response to both the expiration of the predetermined and finite period of time and the human worker's completion of the mandated offline training.

4. The computing device of claim 3, wherein the mandating is based on a quantity of previous times the quality of the results generated by the human worker were detected to be below the predetermined quality threshold.

5. The computing device of claim 1, comprising further computer-executable instructions that, when executed by the processing units, cause the computing device to perform further steps comprising disqualifying the human worker from again performing, without subsequent qualification, useful work by receiving the intelligence tasks and providing the results thereto, the disqualifying being conditioned upon a quantity of previous times the quality of the results generated by the human worker were detected to be below the predetermined quality threshold exceeding a predetermined quantity.

6. The computing device of claim 1, comprising further computer-executable instructions that, when executed by the processing units, cause the computing device to perform further steps comprising:
providing training to the human worker prior to providing qualification intelligence tasks to the human worker; and
qualifying the human worker to perform the useful work only if results generated by the human worker in response to the qualification intelligence tasks are of greater quality than predetermined qualification quality thresholds.

7. The computing device of claim 6, wherein the human worker is provided compensation for completing the training and the qualification.

8. The computing device of claim 7, wherein the compensation comprises increased payments for the performance of the useful work.

9. A computing device for improving quality of results to intelligence tasks, the results being generated by a human worker within a crowdsourcing system, the computing device comprising one or more processing units and computer-readable media comprising computer-executable instructions that, when executed by the processing units, cause the computing device to perform steps comprising:
providing training to the human worker prior to providing qualification intelligence tasks to the human worker;
qualifying the human worker to perform useful work, comprising generating the results to the intelligence tasks, only if results generated by the human worker in response to the qualification intelligence tasks are of greater quality than predetermined qualification quality thresholds;
compensating the human worker for the performance of the useful work; and
compensating, in addition to the compensation for the performance of the useful work, the human worker for completing the training and the qualification.

10. The computing device of claim 9, wherein the compensating the human worker for completing the training and the qualification comprises increasing the compensating the human worker for the performance of a discrete portion of the useful work.

11. The computing device of claim 9, wherein the compensating the human worker for completing the training and the qualification comprises progressively increasing the compensating the human worker for the performance of discrete portions of the useful work, each discrete portion being associated with progressively increased compensation.

12. The computing device of claim 9, comprising further computer-executable instructions that, when executed by the processing units, cause the computing device to perform further steps comprising:
detecting that the quality of the results generated by the human worker are below a predetermined quality threshold;
preventing, for a predetermined and finite period of time, the human worker from generating further results to intelligence tasks of a same overall task as the intelligence tasks to which the human worker generated the results that were detected to be below the predetermined quality threshold, the preventing being triggered by the detecting of the quality of the results being below the predetermined quality threshold;
enabling the human worker to again perform useful work only in response to an expiration of the predetermined and finite period of time;
detecting that the results generated by the human worker exceed the predetermined quality threshold but that the results generated by the human worker directed to at least one specific nuance of the intelligence tasks are of lesser quality than the results generated by the human worker directed other specific nuances of the intelligence tasks; and
providing online training, while the human worker remains enabled to perform useful work, the online training being directed to the at least one specific nuance of the intelligence tasks, the providing being triggered by the detecting of results directed to the at least one specific nuance being of lesser quality than the results directed to the other specific nuances.

13. A method for improving quality of results to intelligence tasks, the results being generated by a human worker within a crowdsourcing system, the method comprising the steps of:
detecting that the quality of the results generated by the human worker are below a predetermined quality threshold;
preventing, for a predetermined and finite period of time, the human worker from generating further results to intelligence tasks of a same overall task as the intelligence tasks to which the human worker generated the results that were detected to be below the predetermined quality threshold, the preventing being triggered by the detecting of the quality of the results being below the predetermined quality threshold;
enabling the human worker to again perform useful work by receiving intelligence tasks and providing results thereto only in response an expiration of the predetermined and finite period of time;
detecting that the results generated by the human worker exceed the predetermined quality threshold but that the results generated by the human worker directed to at least one specific nuance of the intelligence tasks are of lesser quality than the results generated by the human worker directed other specific nuances of the intelligence tasks; and
providing online training, while the human worker remains enabled to perform useful work, the online training being directed to the at least one specific nuance of the intelligence tasks, the providing being triggered by the detecting of results directed to the at least one specific nuance being of lesser quality than the results directed to the other specific nuances.

14. The method of claim 13, wherein the detecting of the quality of the results being below the predetermined quality threshold comprises estimating the quality of the results based upon a comparison between results to gold intelligence tasks generated by the human worker and predetermined definitive correct results corresponding to the gold intelligence tasks.

15. The method of claim 13, comprising further computer-executable instructions that, when executed by the processing units, cause the computing device to perform further steps comprising mandating that the human worker perform offline training during the predetermined and finite period of time; wherein the enabling is performed only in response to both the expiration of the predetermined and finite period of time and the human worker's completion of the mandated offline training.

16. The method of claim 15, wherein the mandating is based on a quantity of previous times the quality of the results generated by the human worker were detected to be below the predetermined quality threshold.

17. The method of claim 13, further comprising the steps of disqualifying the human worker from again performing, without subsequent qualification, useful work by receiving the intelligence tasks and providing the results thereto, the disqualifying being conditioned upon a quantity of previous times the quality of the results generated by the human worker were detected to be below the predetermined quality threshold exceeding a predetermined quantity.

18. The method of claim 13, further comprising the steps of:
providing training to the human worker prior to providing qualification intelligence tasks to the human worker; and
qualifying the human worker to perform the useful work only if results generated by the human worker in response to the qualification intelligence tasks are of greater quality than predetermined qualification quality thresholds.

19. The method of claim 18, wherein the human worker is provided compensation for completing the training and the qualification.

20. The method of claim 18, wherein the compensation comprises increased payments for the performance of the useful work.
